(19) United States
(12) Patent Application Publication
(10) Pub. No.: US 2026/0178751 A1
(43) Pub. Date: Jun. 25, 2026

(54) SYSTEM AND METHOD FOR DATA PRIVACY AND USER INTERFACE LOGGING

(71) Applicants: Narsinga Rao YAMSANI, Tallahassee, FL (US); Kiran Kumar REDDY, Tallahassee, FL (US)

(72) Inventors: Narsinga Rao YAMSANI, Tallahassee, FL (US); Kiran Kumar REDDY, Tallahassee, FL (US)

(21) Appl. No.: 19/534,530

(22) Filed: Feb. 9, 2026

(51) Int. Cl. G06F 21/60; G06F 21/57; G06F 21/62

(52) U.S. Cl. CPC G06F 21/602; G06F 21/57; G06F 21/575; G06F 21/6218

(57) ABSTRACT

The present invention relates to a system and method for data privacy and user interface logging implemented through a physically structured computing device that enforces security, integrity, and controlled disclosure at the point of human-machine interaction. The system captures real-time user interface signals, including user input actions and visual state transitions, through a dedicated interception structure positioned between an input surface and an output display. The captured interactions are converted into structured event representations, cryptographically sealed using device-bound keys, time-stamped through a secure synchronization mechanism, and chained to prior records to form a continuous and tamper-evident log sequence. The sealed records are stored in physically isolated memory partitions that prevent unauthorized access, modification, or deletion. A privacy enforcement structure authenticates access requests, applies disclosure limitation rules, selectively decrypts and masks sensitive fields, and permits only authorized reconstruction of interaction sessions through a verification interface.

### TECHNICAL FIELD OF THE INVENTION

The present invention relates generally to the field of secure computing architectures and human-machine interaction monitoring systems, and more particularly to a physically embodied data processing system and associated operational method for capturing, encrypting, storing, verifying, and selectively disclosing user interface interaction records while preserving data privacy, tamper resistance, and controlled traceability within regulated digital environments.

### BACKGROUND OF THE INVENTION

Modern computing environments increasingly rely on interactive user interfaces for accessing confidential systems, financial platforms, medical records, cloud-based workspaces, and mission-critical digital services. Conventional user activity logging systems either record data in plain or lightly protected formats, or store logs centrally without structural safeguards against manipulation, leakage, or unauthorized inspection. Existing software-based logging approaches are vulnerable to memory scraping, log injection, deletion attacks, screen capture abuse, and unauthorized replication. Additionally, regulatory frameworks require accountability while simultaneously demanding privacy protection and selective disclosure, a dual requirement that existing logging systems are structurally incapable of fulfilling.

There is therefore a need for a physically structured computing system capable of performing user interface event capture, cryptographic sealing, tamper-evident storage, and privacy-preserving access verification through an integrated machine architecture that enforces security at the structural level rather than through software instructions alone.

Modern information systems rely heavily on comprehensive interaction logging to support security monitoring, regulatory compliance, forensic investigation, and user experience analytics. Traditional approaches to logging capture events at the software layer: operating system audit subsystems record system calls and process events, application-level logging frameworks capture business events and user actions, and network appliances collect packet and flow metadata. These solutions provide rich telemetry but are limited by their trust boundaries and the ease with which recorded artifacts can be manipulated, deleted, or spoofed when an attacker achieves sufficient privilege. Centralized log aggregation platforms such as SIEM (Security Information and Event Management) systems and log analytics engines improve visibility by consolidating streams from disparate sources and applying correlation rules, alerting, and retention policies. However, centralized architectures create attractive single points of failure and require robust transport and storage security to prevent interception or tampering in transit and at rest. In many deployments the chain-of-custody for logs is weak: logs are buffered in volatile memory, written to mutable file systems, and indexed in databases that themselves may be subject to administrative compromise. Consequently, traditional software-centric logging is insufficient where an evidentiary-grade, privacy-preserving, and tamper-evident record of user interface interactions is required.

To address integrity concerns, cryptographic log sealing techniques have been proposed and widely adopted. Systems that compute integrity hashes over sequences of log entries, append hash chains, and periodically anchor digests to external trusted roots (for example, public timestamping services or immutable ledgers) materially increase the difficulty of undetectable log modification. Hardware-backed key protection mechanisms, such as Trusted Platform Modules (TPMs) and Hardware Security Modules (HSMs), are frequently used to isolate signing keys and to perform on-device cryptographic operations. These mechanisms harden the keys responsible for sealing logs, so that an attacker must physically compromise hardware or exploit vulnerabilities in secure element firmware to forge signatures. Despite these improvements, cryptographic sealing approaches still face practical limitations: anchoring to external roots introduces dependency on third-party availability and confidentiality trade-offs; key lifecycle management across distributed fleets is operationally complex; and off-device verification often requires the transmission of log material to external verifiers, raising privacy and bandwidth concerns. In addition, hash-chaining mitigates undetected tampering only after the fact and does not prevent real-time interception or leakage of sensitive interface content before sealing.

Beyond integrity, preserving privacy while retaining auditability has become a central challenge. Techniques such as redaction, pseudonymization, and selective disclosure seek to balance the need for accountability with regulatory obligations to minimize exposure of personal data. More advanced cryptographic primitives including homomorphic encryption and secure multi-party computation promise computation over encrypted logs without revealing raw content, and differential privacy provides statistical guarantees that aggregated outputs do not disclose individuals' private attributes. In practice, these approaches are constrained by performance and expressiveness. Homomorphic operations and multi-party protocols are orders of magnitude slower than plain-text processing and are difficult to integrate into low-latency verification workflows. Differential privacy is well suited to aggregate analytics but does not readily support the reconstruction of individual sessions required for legal or forensic processes. Selective disclosure mechanisms often rely on complex policy engines and secure indexing, which increase system complexity and introduce new attack surfaces if policy evaluation components are compromised.

A parallel class of solutions focuses on endpoint resilience and measurement: secure kernels, micro-hypervisors, and trusted execution environments (TEEs) such as Intel SGX or ARM TrustZone attempt to confine logging and sealing logic to isolated execution domains that are less susceptible to compromise by the host operating system. TEEs can capture interaction artifacts and perform cryptographic sealing within a protected enclave. However, TEEs come with their own practical drawbacks: enclave boundaries are limited in memory and I/O capability, side-channel leakage from caches and speculative execution has been demonstrated in multiple platforms, and enclave attestation mechanisms add complexity to provisioning and verification. Moreover, TEEs typically protect compute but not the peripheral I/O paths; keystroke sniffing, screen capture, or display path interception can capture sensitive UI content before it enters the trusted domain. These gaps mean that TEEs alone do not comprehensively address the problem of tamper-evident, privacy-preserving user interface logging.

Emerging proposals have advocated the use of distributed ledger technologies (DLT) or blockchain-like anchoring to create immutable, verifiable records with decentralized trust. Anchoring log digests to a permissioned or public ledger can provide widespread verifiability and a persistent audit trail. Yet, ledger-based architectures introduce latency, scalability, and confidentiality issues: publishing verifiable digests at scale can incur substantial costs and throughput limitations, and public ledgers may expose metadata or timing patterns that enable inference attacks. Permissioned ledgers mitigate some concerns but reintroduce governance and trust management burdens, effectively shifting the trust problem rather than eliminating it.

Additionally, ledger anchoring addresses integrity at the level of digests rather than preserving the confidentiality of the underlying UI content; extraction of meaningful, privacy-safe evidence still requires careful encryption and policy-controlled disclosure mechanisms.

From an operational and human factors perspective, many logging systems fail to preserve meaningful context about the user experience. Low-level telemetry such as system events, network flows, or application logs often omits the visual and temporal structure of the user interface-screen compositions, DOM changes, rendered widgets, and the precise sequencing and timing of pointer movements and touch events. For forensic reconstruction, the absence of UI-context impairs the ability to distinguish between automated script interactions, benign user behavior, and fraudulent manipulation. Attempts to capture richer UI traces through screen recording or session replay yield voluminous data and carry high privacy risk; full-frame recordings are both storage intensive and prone to exposing highly sensitive content such as personal identifiers and authentication tokens. Strategies that capture UI state snapshots at coarse granularity reduce storage burden but may miss critical transitory artifacts.

Finally, systems designed to provide strong logging guarantees are often difficult to retrofit into existing enterprise environments. Heterogeneous application stacks, legacy peripherals, cloud-hosted services, and varying regulatory regimes create integration friction. Administrators face difficult trade-offs between usability, latency, and security guarantees; overly aggressive logging or restrictive disclosure policies can negatively affect user experience and operational throughput, whereas permissive configurations erode audit value. Key management, secure update delivery, forensic retrieval workflows, and long-term archival retention policies require coordinated cross-organizational practices that many deployments lack. In summary, existing solutions each address facets of the problem-integrity, confidentiality, availability, or context—but none offers a comprehensive, deployable approach that simultaneously ensures tamper resistance at the physical I/O boundary, cryptographic protection of collected UI artifacts, efficient privacy-preserving disclosure, and practical manageability across diverse operational environments. These persistent gaps motivate an integrated machine-structured approach that rethinks the point of capture, the physical trust boundary, and the policy-enforced disclosure pathways to achieve forensic-grade, privacy-aware user interface logging.

### SUMMARY OF THE INVENTION

The present invention discloses a system and method for data privacy and user interface logging implemented through a physically embodied computing device comprising an interconnected enclosure-supported structure of functional processing sections, signal routing pathways, encrypted memory assemblies, hardware-bound cryptographic controllers, timing synchronizers, secure event collectors, and verification interfaces. The system records user interface interaction data such as keystrokes, screen transitions, pointer movements, command selections, application state changes, and transactional confirmations, transforms the captured signals into encrypted log objects, cryptographically anchors each object to a secure time chain, and stores the objects in tamper-evident memory partitions that can only be accessed through identity-verified physical and logical authorization pathways.

The method includes the physical capture of interface signals at the input-display boundary, cryptographic sealing using device-bound keys, secure compartmentalization of logs, integrity verification using chained hash structures, selective privacy-preserving disclosure, and controlled log rendering through a verification interface.

The primary object of the present invention is to provide a physically embodied system and method that enable secure, tamper-evident, and privacy-preserving logging of user interface interactions by structurally enforcing trust at the point where human input and machine output converge, rather than relying solely on software-level controls that are vulnerable to manipulation, interception, or unauthorized modification.

Another object of the invention is to ensure that all user interface events, including visual transitions, command selections, input actions, and state changes, are captured in real time through an integrated machine structure and transformed into cryptographically sealed records that cannot be altered, deleted, or replayed without detection, thereby establishing a continuous and verifiable chain of interaction evidence.

A further object of the invention is to provide a secure storage architecture that physically isolates log records within protected memory compartments and enforces access control through embedded authentication and authorization pathways, so that only verified entities may retrieve or inspect interaction logs, and only within a disclosure scope that preserves user privacy.

Another object of the invention is to enable controlled, privacy-preserving disclosure of interaction records through a verification interface that applies selective masking, field-level encryption, and contextual filtering, thereby allowing compliance audits, forensic investigations, and dispute resolution processes to occur without exposing unnecessary or sensitive personal information.

A further object of the invention is to integrate cryptographic sealing, time synchronization, and integrity chaining directly into the structural architecture of the device, such that each recorded interaction is bound to a secure temporal reference and to a previous event, creating a non-repudiable sequence of records that can be independently verified for authenticity.

Another object of the invention is to prevent real-time interception, replay, and manipulation of user interface data by enforcing signal interception, encryption, and routing through dedicated internal conduction pathways that are physically isolated from general processing sections, thereby eliminating opportunities for unauthorized data leakage.

A further object of the invention is to provide a scalable and adaptable machine architecture that can be deployed across diverse computing environments, including enterprise workstations, secure terminals, cloud access kiosks, regulatory compliance systems, and forensic audit platforms, without requiring invasive modifications to existing software ecosystems.

Another object of the invention is to enhance accountability and trust in digital systems by enabling verifiable reconstruction of user interface sessions, while simultaneously complying with data protection regulations and minimizing the risk of privacy breaches through built-in disclosure governance mechanisms.

A further object of the invention is to reduce administrative overhead and security complexity by embedding key management, integrity verification, and privacy enforcement directly within the device structure, thereby eliminating reliance on external trust anchors or centralized logging infrastructures that introduce single points of failure.

Yet another object of the invention is to provide a long-term, forensically reliable interaction record that remains verifiable over time, resistant to environmental or operational tampering, and capable of supporting legal, regulatory, and security requirements without compromising the confidentiality and dignity of system users.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for data privacy and user interface logging; and

FIG. 2 displays flow chart of a method for data privacy and user interface logging.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

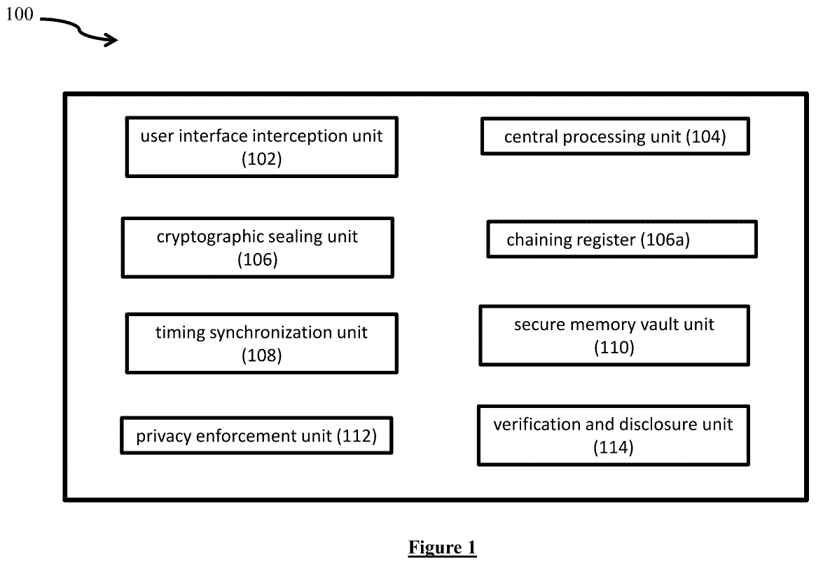

Referring to FIG. 1, a block diagram of a system for data privacy and user interface logging, the system comprising a housing structure enclosing and supporting a plurality of operatively interconnected processing and signal control units, wherein the housing defines an internal protected cavity having physically separated signal routing pathways, is illustrated. The system 100 comprises: a user interface interception unit (102) positioned along a signal path extending between a user input surface and a visual output surface, the user interface interception unit being configured to receive, convert, and forward real-time interface interaction signals representing user actions and visual state transitions; a central processing unit (104) operatively coupled to the user interface interception unit and configured to receive structured interaction event signals; a cryptographic sealing unit (106) operatively coupled to the central processing unit, the cryptographic sealing unit comprising a key storage processor, a hashing processor, an encryption processor, and a chaining register (106a) configured to transform each interaction event signal into a sealed log record bound to a previous log record through a chained integrity reference; a timing synchronization unit (108) comprising a secure clock source and timestamp generation circuitry configured to apply a time reference to each sealed log record prior to storage; a secure memory vault unit (110) comprising a plurality of physically isolated memory partitions having gated access conductors, the secure memory vault unit being configured to store the sealed log records and to restrict read and write operations to authenticated pathways; a privacy enforcement unit (112) operatively coupled to the secure memory vault unit and configured to authenticate log access requests, apply disclosure limitation rules, and selectively decrypt and mask portions of stored log records; and a verification and disclosure unit (114) operatively coupled to the privacy enforcement unit and configured to validate chained integrity of the sealed log records and reconstruct authorized user interface interaction sequences for controlled presentation.

In an embodiment, the user interface interception unit (102) comprises a signal capture array arranged between the user input surface and the visual output surface such that all interface interaction signals are routed through the signal capture array prior to reaching the central processing unit, and wherein the signal capture array includes event normalization circuitry that converts raw signal transitions into structured event representations.

In an embodiment, the cryptographic sealing unit (106) is physically isolated within a tamper-resistant enclosure region of the housing and comprises a device-bound key storage processor that generates and retains cryptographic keys which are inaccessible to the central processing unit through direct memory access.

In an embodiment, the chaining register (106a) of the cryptographic sealing unit is configured to store a previous integrity reference and to combine the previous integrity reference with a current interaction event signal prior to hashing, thereby forming a sequential dependency across all sealed log records.

In an embodiment, the timing synchronization unit (108) comprises a dedicated oscillator and a time verification circuit configured to detect clock drift and to prevent the generation of duplicate or regressive timestamps.

In an embodiment, the secure memory vault unit (110) comprises electrically isolated memory segments separated by access gate transistors that remain nonconductive unless an authentication token generated by the cryptographic sealing unit is verified by the privacy enforcement unit.

In an embodiment, the secure memory vault unit (110) further comprises a tamper detection conductor grid embedded within the housing, the grid being configured to trigger memory lockdown and cryptographic key invalidation when physical breach of the housing is detected.

In an embodiment, the privacy enforcement unit (112) comprises an identity verification processor, an access policy comparator, and a data masking processor configured to remove or obfuscate selected fields from the sealed log records prior to disclosure.

In an embodiment, the data masking processor is configured to replace visual content segments of the sealed log records with structural metadata representations that preserve event sequence while removing user-identifiable content.

In an embodiment, the verification and disclosure unit (114) comprises an integrity validation processor configured to sequentially recomputed chained integrity references and to generate a validation status prior to permitting reconstruction of any user interface interaction sequence.

In an embodiment, the event normalization circuitry of the signal capture array is configured to intercept heterogeneous signal transitions originating from the user input surface and the visual output surface and to convert the intercepted signal transitions into structured interaction event representations by sequentially sampling signal voltage variations, detecting transition edges, mapping the detected transition edges to predefined interaction event categories, and generating standardized event packets containing event type identifiers, positional references, and state-change indicators, and wherein the structured event packets are transmitted to the central processing unit through a dedicated routed pathway that bypasses unverified intermediate logic paths.

In an embodiment, the event normalization circuitry operates as a continuously active electrical interpretation layer that receives raw signal fluctuations originating from both the user input surface and the visual output surface and converts those fluctuations into coherent, structured interaction representations suitable for secure processing. The circuitry samples voltage levels across multiple conductive sensing lines at defined intervals, capturing transient changes caused by actions such as touch contact, movement across the input surface, release of pressure, or dynamic updates occurring on the display layer. These sampled values are processed through edge detection components that identify the precise moment a signal transitions from one state to another, such as when a finger first contacts a touch region, moves across coordinates, or lifts away. Each detected transition is then evaluated against internally stored event classification patterns that associate specific electrical behaviors with known categories

In an embodiment, the signal capture array further comprises a buffering controller configured to temporarily queue the structured interaction event representations in a controlled sequence and to regulate forwarding of the structured interaction event representations to the central processing unit in synchronization with receipt acknowledgment signals, such that no interaction event representation is lost, overwritten, or reordered during transmission.

In an embodiment, the buffering controller functions as an intermediate hardware-managed sequencing mechanism that temporarily retains each structured interaction event representation immediately after it is generated by the signal capture array and before it is delivered to the central processing unit. The controller maintains an ordered storage structure in which incoming event packets are written sequentially into temporary holding registers or memory cells, with each stored packet associated with an internal sequence index reflecting its exact arrival order. As the central processing unit completes processing of a previously received packet, it transmits a receipt acknowledgment signal back to the buffering controller, which then releases the next event packet in the preserved sequence. This controlled handshaking operation ensures that event packets are forwarded only when the receiving circuitry is ready, thereby preventing data collision, partial overwriting, or loss of high-frequency interaction signals. For example, during rapid user interactions such as continuous typing, fast scrolling, or repeated tapping, multiple event representations may be generated in quick succession within very short time intervals; the buffering controller absorbs this burst of activity by staging the packets in order and spacing their transmission according to acknowledgment timing, thereby preserving the chronological integrity of the interaction stream. The buffering controller also prevents reordering by restricting access to the stored packets until prior entries have been transmitted and confirmed, ensuring that earlier events cannot be bypassed by later ones. This approach maintains a precise one-to-one correspondence between physical user actions and processed interaction records, even under conditions of variable processing load or temporary latency in the central processing unit, resulting in consistent and reliable propagation of interaction data through the system.

In an embodiment, the chaining register is configured to combine the stored previous integrity reference with the current interaction event signal by concatenating a representation of the previous integrity reference with a structured representation of the current interaction event signal and a corresponding timestamp reference received from the timing synchronization unit prior to forwarding the combined data to the hashing processor, such that each sealed log record is formed as a dependent transformation of both a preceding sealed log record and a current interaction event.

In an embodiment, the chaining register operates as a sequential dependency-forming hardware element that receives the integrity reference retained from a previously generated record and electronically merges that reference with the structured representation of a newly received interaction event signal along with its associated timestamp reference obtained from the timing synchronization unit. This merging process is performed by assembling the prior integrity reference, the current event data fields, and the time reference into a single ordered data structure within the register, such that the earlier reference occupies a defined position relative to the new event information. The register temporarily holds this composite representation and forwards it in its entirety to the hashing processor for transformation, ensuring that the output produced for the current record is mathematically and structurally linked to both the preceding stored record and the present interaction occurrence. For example, when a sequence of user actions occurs, such as opening an interface element followed by entering information and confirming the entry, the chaining register ensures that the record generated for each step carries forward the reference derived from the previous step. If any earlier record were altered or removed, the subsequent combined representations would no longer align with their derived values, allowing the system to identify inconsistencies. This continuous dependency formation creates a cumulative record structure in which each stored entry inherently carries the influence of the entire preceding sequence, thereby preserving chronological continuity and strengthening resistance to undetected modification while maintaining accurate association between event timing and interaction context.

In an embodiment, the timing synchronization unit is configured to coordinate generation of timestamp references by continuously comparing oscillation cycles from the dedicated oscillator against a reference cycle counter, identifying timing irregularities, and inhibiting timestamp generation when a deviation beyond a predefined drift tolerance is detected, and wherein the timing synchronization unit resumes timestamp issuance only after a verified time alignment condition is re-established.

In an embodiment, the timing synchronization unit maintains a stable and verifiable time reference by continuously monitoring oscillation cycles generated by the dedicated oscillator and comparing the detected cycles against an internally maintained reference cycle counter that represents an expected timing progression. The unit includes monitoring circuitry that counts oscillator pulses over defined intervals and checks whether the measured frequency and phase alignment remain within an acceptable tolerance range. When environmental variations such as temperature shifts, electrical noise, or aging of components cause the oscillator to drift slightly from its intended frequency, the comparison logic detects the mismatch by identifying discrepancies between the expected cycle count and the actual observed count. If the deviation exceeds a predefined tolerance threshold, the timestamp generation circuitry temporarily suspends the issuance of new timestamp references so that inaccurate time values are not attached to interaction records. For example, if the oscillator momentarily speeds up due to a transient power fluctuation, producing time increments faster than expected, the unit recognizes the irregularity and prevents timestamp output until the oscillation stabilizes and the cycle count once again aligns with the reference counter. During this stabilization phase, internal correction mechanisms allow the oscillator signal to be re-evaluated over successive cycles until the difference falls within acceptable limits. Once alignment is verified, the unit resumes timestamp generation and reattaches time references to subsequent interaction events. This approach ensures that each timestamp corresponds to a reliable and sequential time progression, preventing overlapping, regressive, or duplicated time entries and preserving the chronological accuracy of the recorded interaction sequence.

In an embodiment, the authentication token generated by the cryptographic sealing unit is dynamically produced for each write operation by deriving a token value from at least a portion of the sealed log record and a time reference generated by the timing synchronization unit, and wherein the privacy enforcement unit is configured to validate the token value prior to enabling conduction through the access gate transistors of a selected memory partition to permit storage of the sealed log record.

In an embodiment, the authentication token is produced as a transient, operation-specific value that is generated at the moment a sealed log record is prepared for storage, ensuring that each write action is uniquely authorized and traceable to a particular event instance. The cryptographic sealing unit derives this token by extracting selected portions of the sealed log record, such as the transformed interaction representation and its associated integrity reference, and combining those portions with a contemporaneous time reference supplied by the timing synchronization unit. The combined data is processed within the sealing circuitry to generate a token value that is inherently bound to both the content and the precise moment of the write operation. This token is transmitted alongside the sealed log record to the privacy enforcement unit, which includes validation circuitry configured to independently derive a corresponding expected token from the received record and time reference. The privacy enforcement unit then compares the generated token with the expected value and, only upon a successful match, issues a control signal that activates the access gate transistors connected to a designated memory partition. When the gate transistors become conductive, the sealed log record is permitted to pass into the selected storage region; if the token does not match, the conductive pathway remains disabled, preventing any write action from occurring. For example, when a user interaction is recorded and sealed, the system produces a token tied specifically to that interaction and its timestamp, and only that valid token can open the gated pathway for storage. If an attempt is made to insert an altered or externally introduced record, the absence of a correctly derived token prevents the memory pathway from activating. This mechanism tightly couples content verification with physical storage control, ensuring that only properly sealed and time-consistent records are committed to memory while maintaining controlled and authenticated write operations.

In an embodiment, the tamper detection conductor grid is configured to continuously circulate a verification signal through intersecting conductive traces embedded within the housing, and wherein interruption, attenuation, or distortion of the verification signal results in generation of a tamper event signal that is routed to the cryptographic sealing unit to initiate immediate invalidation of active cryptographic key references stored within the key storage processor.

In an embodiment, the tamper detection conductor grid operates as an embedded electrical integrity monitoring network formed by a pattern of intersecting conductive traces routed across multiple structural layers within the housing so as to surround and protect the internal circuitry. A low-intensity verification signal is continuously circulated through these conductive paths in a closed-loop manner, and monitoring circuitry measures parameters such as signal continuity, resistance stability, and propagation consistency as the signal travels through the grid. Because the traces are distributed across critical structural regions, any attempt to physically penetrate, drill, cut, or pry open the housing causes at least one portion of the conductive path to stretch, break, or change its electrical characteristics. When such a change occurs, the verification signal becomes interrupted, attenuated, or distorted, and detection circuitry immediately identifies the anomaly by comparing the returning signal characteristics against expected baseline values. Upon detection of such an irregularity, a tamper event signal is generated and routed directly to the cryptographic sealing unit through a dedicated conductor path. The cryptographic sealing unit responds by initiating rapid invalidation of active cryptographic key references stored within the key storage processor, which may include clearing key registers, disabling access to stored key material, or overwriting sensitive values held in volatile storage. For example, if an external entity attempts to open the enclosure to access the internal memory vault, even a slight deformation of the housing structure alters the continuity of the embedded grid, triggering immediate detection and protective action before internal components can be exposed. This arrangement ensures that physical intrusion attempts are detected in real time and that the internal security state transitions into a protected condition without requiring external intervention, thereby preserving the confidentiality and integrity of stored data and preventing subsequent unauthorized cryptographic operations.

In an embodiment, the identity verification processor of the privacy enforcement unit is configured to receive an access request containing a requester identity representation and to generate a verification result by comparing the requester identity representation with stored authentication credentials, and wherein the access policy comparator is configured to evaluate the verification result against a set of disclosure limitation rules to determine permitted fields within the sealed log records for disclosure.

In an embodiment, when an access request is initiated, the identity verification processor receives a digitally encoded requester identity representation transmitted through a secured input pathway, which may include credential information derived from a hardware token, biometric interface signal, or encrypted identity descriptor stored in a protected device region. The processor converts the received representation into a normalized comparison format and performs a direct matching operation against authentication credentials maintained in a protected credential storage area that is electrically isolated from general-purpose processing pathways. The comparison is performed by evaluating multiple credential attributes such as identifier patterns, verification codes, and session-linked validation markers to determine whether the incoming identity corresponds to an authorized entity. Once the comparison produces a verification result, that result is passed to the access policy comparator, which contains rule evaluation circuitry configured to interpret predefined disclosure limitation conditions mapped to different categories of verified identities. The access policy comparator examines the verified identity classification and determines which portions of the sealed log records may be made available by selectively identifying permissible data segments and restricting access to other segments that exceed the disclosure scope associated with the requester. For example, an authenticated supervisory identity may be permitted to access interaction timing information and system response indicators, while sensitive content fields associated with user actions remain restricted, whereas a higher authorization level may enable access to broader contextual data. The decision outcome is translated into control signals that guide downstream retrieval circuitry so that only the allowed fields are extracted from the memory vault for further processing. This layered verification and rule evaluation approach ensures that disclosure is tightly controlled based on identity-specific permissions, enabling precise differentiation between authorized and restricted data elements while maintaining consistent protection of sensitive interaction information.

In an embodiment, the data masking processor is configured to process the sealed log records by identifying visual content segments associated with user interface rendering states, extracting structural parameters including event timing, interaction type, and interface region reference, and replacing pixel-level or character-level content with encoded structural metadata tokens that retain interaction sequence continuity while suppressing user-identifiable data elements.

In an embodiment, the data masking processor operates as a transformation stage that receives decrypted portions of the sealed log records and analyzes the contained visual content representations in relation to the recorded interaction context. The processor includes parsing circuitry that separates rendering state information from associated structural parameters and identifies portions of the record that correspond to display elements, text content, graphical regions, and user-entered data captured during interface activity. Once these visual segments are detected, the processor extracts underlying structural descriptors such as the exact time at which the interaction occurred, the nature of the action performed, and the positional reference indicating the interface region in which the action took place. Instead of retaining the original pixel-level or character-level data that could reveal identifiable information, the processor replaces those portions with encoded structural metadata tokens that preserve the logical meaning of the event without exposing the actual visual content. For example, if a user enters text into a form field, the processor removes the characters entered and substitutes a token indicating the presence of a text-entry action, its location within a specific interface field, and the timing associated with the input. Similarly, if a visual element is selected or activated, the processor replaces the detailed image representation with a metadata reference describing the interaction type and the region of activation. This transformation maintains continuity of the interaction sequence by preserving timing, order, and contextual references while eliminating content that could identify a user or reveal sensitive information. As a result, reconstructed sequences remain meaningful for analysis of behavior patterns, system responses, or operational flow, while sensitive visual data is prevented from being disclosed or reconstructed from the stored records.

In an embodiment, the integrity validation processor is configured to sequentially retrieve stored sealed log records from the secure memory vault unit, extract a stored chained integrity reference from each sealed log record, recompute a corresponding integrity value by combining a preceding integrity reference with associated structured interaction event representations and timestamp references, and compare the recomputed integrity value with the stored chained integrity reference to determine continuity of the sealed log record chain.

In an embodiment, the integrity validation processor operates by initiating a controlled retrieval sequence in which sealed log records are accessed from the secure memory vault unit in their stored order using authorized read pathways. For each retrieved record, the processor extracts the chained integrity reference embedded within that record along with the associated structured interaction event representation and the timestamp reference that was originally applied at the time of sealing. The processor then reconstructs an expected integrity value by electronically combining the integrity reference derived from the immediately preceding record with the current event representation and its corresponding timestamp in the same structured format used during the original record formation process. This reconstructed composite is passed through an internal transformation stage identical to the one used at the time of initial record creation so that a new integrity value is generated under the same conditions. The processor then performs a direct comparison between the newly generated value and the stored chained integrity reference present within the retrieved record. This process is repeated sequentially across successive records, ensuring that each entry is validated in the context of the one that came before it. For example, when reviewing a sequence of stored interaction records corresponding to a series of user actions, the processor starts from an initial known reference point and verifies that each subsequent record maintains continuity with its predecessor; if any record has been altered, removed, or inserted out of sequence, the recomputed value will not match the stored reference, immediately indicating a break in the continuity of the record chain. By performing this validation step in sequence and tying each verification outcome to the previous reference, the system maintains a consistent and traceable linkage across all stored records, enabling reliable detection of inconsistencies while preserving the chronological integrity of the interaction history.

In an embodiment, the verification and disclosure unit further comprises a sequence reconstruction processor configured to reconstruct authorized user interface interaction sequences by arranging validated sealed log records in chronological order based on the applied time references, decoding structured interaction event representations, and generating a controlled playback representation corresponding to permitted disclosure parameters defined by the privacy enforcement unit.

In an embodiment, the sequence reconstruction processor operates after the sealed log records have been validated and approved for limited disclosure, and functions to regenerate a coherent representation of past interface activity by organizing the retrieved records according to their associated time references. The processor first reads the validated records from the secure memory vault through an authorized pathway and places them into an ordered buffer where the timestamps are evaluated to establish an exact chronological sequence of occurrence. Once the order is established, the processor decodes the structured interaction event representations contained in each record by interpreting the event type identifiers, positional references, and state-change indicators that describe how the user interface evolved over time. Using these decoded parameters, the processor reconstructs a step-by-step playback model in which interface actions are represented as controlled visual or structural transitions that mirror the original sequence of operations without exposing restricted content. For example, if a sequence of events indicates that a user opened a menu, selected a field, entered information, and confirmed an action, the reconstruction processor generates a timed representation showing the order and location of each interaction, reflecting the flow of activity across the interface. Before producing the playback output, the processor consults the permitted disclosure parameters received from the privacy enforcement unit and filters the reconstructed representation so that only allowed portions of the interaction are displayed, while masked or restricted elements remain abstracted as structural indicators. This coordinated arrangement of validated records, precise decoding of interaction data, and controlled reconstruction ensures that the recreated sequence accurately reflects the timing and progression of the original user interface activity while maintaining strict adherence to access limitations.

In an embodiment, the device-bound key storage processor is configured to generate cryptographic keys through an internal entropy derivation process using time-varying electrical characteristics measured within the tamper-resistant enclosure region, and wherein the generated cryptographic keys are supplied directly to the hashing processor and the encryption processor through internal conductors that are not externally addressable by the central processing unit.

In an embodiment, the device-bound key storage processor produces cryptographic keys by deriving entropy from continuously changing electrical characteristics that naturally occur within the enclosed circuitry environment, such as minute fluctuations in voltage levels, thermal noise across conductive elements, and timing variations measured from internal oscillation behavior. Dedicated sensing circuits within the tamper-resistant enclosure monitor these time-varying signals and convert them into raw entropy values, which are then conditioned through internal transformation stages to produce stable and unpredictable key material. This process occurs entirely within the protected boundary of the enclosure so that the generated keys are intrinsically tied to the physical state of the specific device and cannot be replicated by external systems. Once generated, the keys are retained within the key storage processor and delivered directly to the hashing processor and the encryption processor through fixed internal conductors that are embedded within the hardware layout and electrically isolated from general-purpose data buses. These conductors provide a one-directional transfer path that prevents the central processing unit or any external interface from reading, copying, or modifying the key material. For example, during the sealing of an interaction event, the hashing and encryption processors receive the required key values through these internal paths at the moment of transformation, use them to produce the sealed record, and then proceed without exposing the key data to any accessible memory region. Because the entropy source is continuously influenced by dynamic electrical conditions and the transfer path remains confined within the protected enclosure, the resulting key generation and usage process remains bound to the hardware environment and resistant to duplication or interception, ensuring that cryptographic operations remain isolated from higher-level processing control.

In an embodiment, the encryption processor is configured to transform each hashed interaction event representation into a sealed log record by applying an encryption transformation that incorporates the hashed value, the timestamp reference, and a device-bound key obtained from the key storage processor, and wherein the encrypted output is written into the chaining register as a current integrity reference for use in generation of a subsequent sealed log record.

In an embodiment, the encryption processor receives the hashed interaction event representation together with the associated timestamp reference and a device-bound key delivered from the key storage processor through the protected internal conductors, and performs a hardware-based transformation that converts these inputs into a sealed log record that is resistant to interpretation or modification. The processor first assembles the hashed value and timestamp into an ordered composite structure and then applies the device-bound key as part of the transformation operation so that the resulting output is uniquely tied to both the specific interaction instance and the hardware environment in which it was produced. This transformation is carried out within a confined processing region using dedicated arithmetic and substitution circuitry that ensures the original hashed content and time reference cannot be directly reconstructed from the sealed output without access to the corresponding key. Once the transformation is completed, the encrypted output is immediately routed into the chaining register, where it is stored as the current integrity reference associated with that interaction. This stored reference then becomes the dependency input for the formation of the next record, allowing the next interaction event to be linked to the previously sealed output. For example, when multiple user interface actions occur in sequence, each newly generated sealed record incorporates the previous encrypted reference through the chaining process, creating a continuous and interdependent progression across all stored records. By incorporating the hashed content, precise timing information, and device-specific key material into each transformation, the process ensures that each sealed record remains uniquely bound to the event that produced it and to the internal hardware state at the time of creation, while also establishing a persistent reference that supports continuity across subsequent record generations.

In an embodiment, the secure memory vault unit is configured to distribute successive sealed log records across different physically isolated memory partitions according to a partition allocation controller that assigns a storage location based on at least a portion of the chained integrity reference, such that sequential sealed log records are not stored within a single contiguous memory segment.

In an embodiment, the secure memory vault unit manages storage of sealed log records by using the partition allocation controller to determine a storage destination for each incoming record based on characteristics derived from the chained integrity reference associated with that record.

The controller receives the current integrity reference from the chaining register and processes selected portions of that reference as an addressing determinant to select one of several physically isolated memory partitions arranged within the vault. Each partition is separated by dedicated conductive barriers and independently gated access paths so that storage operations occur in distinct regions rather than in a single continuous block. When a new sealed log record arrives, the controller interprets the derived portion of the integrity reference as a distribution parameter and activates the access pathway corresponding to the selected partition, allowing the record to be written into that specific location. For example, if successive interaction events produce integrity references that vary in value, each resulting record may be directed to a different partition according to those values, causing the stored records to be dispersed across multiple isolated storage regions. This controlled distribution ensures that even temporally adjacent records are not placed sequentially within the same contiguous memory segment, reducing the likelihood that a localized physical or electrical disturbance could affect a continuous series of stored entries. By associating storage placement with the evolving integrity reference, the system creates a dynamic and non-linear storage pattern that strengthens resistance against targeted extraction or alteration, while still allowing orderly retrieval by reconstructing the sequence through the integrity linkage maintained across the records.

In an embodiment, the central processing unit is configured to coordinate operation of the user interface interception unit, the cryptographic sealing unit, and the timing synchronization unit by issuing event processing triggers upon receipt of structured interaction event signals, initiating timestamp acquisition from the timing synchronization unit, and forwarding the structured interaction event signals together with the corresponding timestamp references to the cryptographic sealing unit for transformation into sealed log records prior to storage within the secure memory vault unit.

In an embodiment, the central processing unit functions as an operational coordination controller that manages the flow of interaction information between the interception circuitry, the timing circuitry, and the sealing circuitry in a tightly synchronized manner. Upon receiving a structured interaction event signal from the user interface interception unit through a defined data pathway, the central processing unit immediately generates an event processing trigger that marks the beginning of a controlled recording cycle. In response to this trigger, the central processing unit requests a time reference from the timing synchronization unit and temporarily holds the structured interaction event representation within an internal buffer while awaiting confirmation that a valid timestamp has been generated. Once the timestamp reference is received, the central processing unit associates the time reference with the corresponding interaction event by embedding the two into a single ordered data structure that preserves the relationship between the occurrence of the event and its temporal context. This combined representation is then forwarded through a dedicated conductor path to the cryptographic sealing unit, ensuring that the event data is transformed into a sealed log record immediately after the time reference is applied. For example, when a user performs an action such as selecting an on-screen element, the interception unit converts that action into a structured signal and delivers it to the central processing unit, which then requests the current time reference, pairs the timestamp with the event data, and transmits the combined information for sealing without delay. This coordinated sequence ensures that every recorded interaction is consistently associated with an accurate time reference and that no event proceeds to storage without first undergoing the sealing transformation. By orchestrating these operations in a synchronized cycle, the central processing unit maintains orderly progression from event capture to time association to secure transformation, resulting in a reliable and traceable recording pipeline that preserves both chronological consistency and structural integrity across all stored interaction records.

In an implementation, the central processing unit is realized as a dedicated hardware processing module mounted within the housing and electrically interconnected with the user interface interception unit, the timing synchronization unit, and the cryptographic sealing unit through defined conductive buses and control lines that enable coordinated signal exchange. The central processing unit includes a processing core formed by arithmetic and control circuitry, an internal buffering region implemented as high-speed memory cells for temporarily holding structured interaction event signals, and control logic configured to generate event processing triggers in response to receipt of incoming event representations from the interception circuitry. The user interface interception unit is embodied as a physical signal acquisition assembly comprising conductive sensing pathways, signal conditioning circuits, and event formatting hardware that deliver structured electrical event representations to the central processing unit through a routed data conductor. The timing synchronization unit is implemented as a hardware timing block including a stabilized oscillator element, counting circuitry, and timestamp generation registers that produce time reference signals upon receiving a request signal from the central processing unit. The cryptographic sealing unit is constructed as a separate hardware module containing transformation circuitry, internal registers, and protected conductors arranged to receive the structured interaction event signals and corresponding timestamp references from the central processing unit for immediate sealing operations. Each of these units is connected by dedicated electrical pathways such that, upon detection of an interaction event, the central processing unit physically issues control signals that initiate timestamp acquisition from the timing synchronization unit, temporarily associates the received timestamp with the buffered interaction event using internal data handling circuitry, and forwards the combined representation through secured internal conductors to the cryptographic sealing unit for transformation into a sealed log record prior to transfer to the secure memory vault unit. All operational exchanges occur through fixed hardware interfaces, including data buses, control signal lines, and gated pathways, thereby establishing a coordinated hardware architecture in which each component performs a distinct electrical function within the overall signal processing and secure recording arrangement.

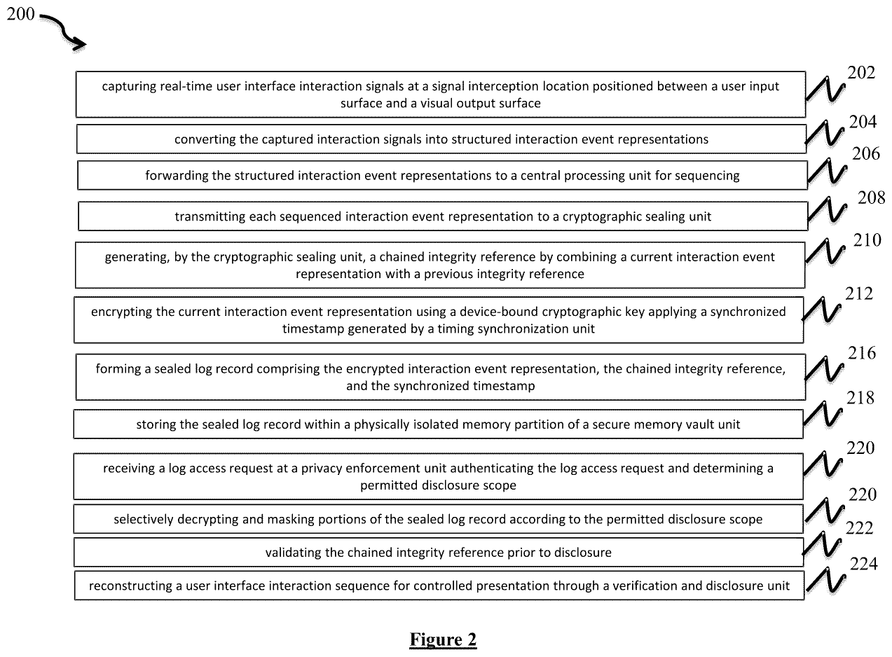

Referring to FIG. 2, a flow chart for a method for data privacy and user interface logging, implemented by a physically structured computing system, the method comprising the steps of is illustrated. The method 200 comprises:
At step 202, the method 200 includes capturing real-time user interface interaction signals at a signal interception location positioned between a user input surface and a visual output surface;
At step 204, the method 200 includes converting the captured interaction signals into structured interaction event representations;
At step 206, the method 200 includes forwarding the structured interaction event representations to a central processing unit for sequencing;
At step 208, the method 200 includes transmitting each sequenced interaction event representation to a cryptographic sealing unit;
At step 210, the method 200 includes generating, by the cryptographic sealing unit, a chained integrity reference by combining a current interaction event representation with a previous integrity reference;
At step 212, the method 200 includes encrypting the current interaction event representation using a device-bound cryptographic key; applying a synchronized timestamp generated by a timing synchronization unit;
At step 214, the method 200 includes forming a sealed log record comprising the encrypted interaction event representation, the chained integrity reference, and the synchronized timestamp; At step 216, the method 200 includes storing the sealed log record within a physically isolated memory partition of a secure memory vault unit;
At step 218, the method 200 includes receiving a log access request at a privacy enforcement unit; authenticating the log access request and determining a permitted disclosure scope;
At step 220, the method 200 includes selectively decrypting and masking portions of the sealed log record according to the permitted disclosure scope;
At step 222, the method 200 includes validating the chained integrity reference prior to disclosure; and
At step 224, the method 200 includes reconstructing a user interface interaction sequence for controlled presentation through a verification and disclosure unit.

In an embodiment, further comprising intercepting all user interface input and visual state transition signals through a signal capture array prior to delivery to the central processing unit, such that no interaction signal bypasses the signal interception location.

In an embodiment, further comprising physically isolating cryptographic key generation and storage from the central processing unit and preventing direct memory access to the cryptographic sealing unit.

In an embodiment, further comprising detecting physical tampering through a conductor grid embedded within a housing and, upon detection, invalidating cryptographic keys and locking access to the secure memory vault unit.

In an embodiment, further comprising generating a disclosure audit record corresponding to each log access request and storing the disclosure audit record within the secure memory vault unit.

In an embodiment, further comprising extracting incremental visual state transitions instead of full rendered frames and associating each transition with a corresponding user input action.

In an embodiment, further comprising operating in a fail-secure mode in which interruption of power or verification failure suspends signal routing and log generation.

During normal operation, all human-machine interaction signals originating from the user input surface and all rendered state signals originating from the visual output surface are first routed through the user interface interception unit. This interception unit performs real-time capture of electrical or digital signal transitions and converts them into normalized event primitives. Each primitive is labeled with a context identifier derived from the interface state and is placed into a temporary sequencing buffer. The central processing unit retrieves each event primitive strictly in arrival order and assigns a monotonic sequence position. The sequencing operation does not modify event content but only determines its temporal ordering prior to cryptographic sealing.

Once sequenced, each event primitive is transmitted to the cryptographic sealing unit through a physically isolated conductor path. Inside the cryptographic sealing unit, a chaining register stores a previously generated integrity reference. The technique first concatenates the current event primitive with the stored integrity reference and forwards the combined structure to the hashing processor. The resulting hash value becomes a new integrity reference and is written back into the chaining register, thereby enforcing a continuous dependency across all events. In parallel, the event primitive is forwarded to the encryption processor, which encrypts the event using a cryptographic key held exclusively within the key storage processor. The key cannot be read by the central processing unit and is only accessible through internal signal gates controlled by the cryptographic sealing unit itself.

The timing synchronization unit operates concurrently with the sealing process. The secure clock source generates a trusted time reference that is verified for continuity and monotonic progression. Each time the cryptographic sealing unit completes the generation of a new integrity reference, the timing synchronization unit injects a corresponding timestamp into the sealed record. The technique rejects any timestamp that is equal to or earlier than a previously issued timestamp, thereby preventing replay or backdating of events.

The encrypted event, integrity reference, and timestamp are then assembled into a sealed log record. The sealed log record is transmitted to the secure memory vault unit, where an access gate controller verifies an authentication token generated by the cryptographic sealing unit before enabling a write pathway into a physically isolated memory partition. Once written, the memory partition enters a write-once state and cannot be overwritten or erased through normal system operation. This enforces a permanent audit trail at the storage layer.

When a request to access stored records is received, the privacy enforcement unit intercepts the request and executes an identity validation technique that compares supplied credentials with internally stored authorization references. If validation is successful, the privacy enforcement unit evaluates a disclosure rule set that defines which data fields, visual state segments, and interaction attributes may be revealed for the requesting identity. The technique then retrieves the corresponding sealed log records from the secure memory vault unit and forwards them to a selective decryption pathway. Only those fields permitted by the disclosure rule set are decrypted, while disallowed fields are either masked or replaced with structural metadata indicating their existence without revealing their content.

Before any decrypted data is released, the verification and disclosure unit performs a chained integrity validation technique. This technique sequentially recomputes integrity references by combining each decrypted event with the previous reference and compares the recomputed result with the stored reference in each sealed log record. Any mismatch immediately halts reconstruction and generates an integrity fault state. When validation is successful, the verification and disclosure unit reconstructs the user interface session by ordering the records according to their timestamps and sequence positions and renders only the authorized portions through a controlled display output.

If at any time the tamper detection grid embedded within the housing senses a breach, the technique transitions the system into a lockdown state. In this state, cryptographic keys are invalidated, access gates to the secure memory vault unit are disabled, and all signal routing pathways are placed into a non-conductive condition. This prevents both live interception and post-event extraction of interaction data.

Through this sequence of enforced technique stages, the invention ensures that every user interface interaction is captured, sealed, chained, time-bound, securely stored, and selectively disclosed in a manner that is resistant to tampering, compliant with privacy requirements, and verifiable for forensic and regulatory purposes.

The system comprises a rigid protective housing formed of conductive and tamper-resistant material, the housing defining an internal structural cavity that supports a central processing section, an interface signal acquisition section, a cryptographic sealing section, a secure memory vault section, a synchronization and time-stamping section, a privacy enforcement section, and a verification and disclosure section, all interconnected through isolated signal conduction paths formed on an internal substrate.

The interface signal acquisition section is physically positioned between a display-output interface plane and a user-input signal plane, such that all user interface interactions must pass through the acquisition section before reaching the central processing section. The acquisition section comprises signal interception channels, event pattern classifiers, and frame extraction circuits that convert raw interface transitions into discrete event packets representing user-visible actions. These event packets are forwarded through a secure bus pathway to the cryptographic sealing section.

The cryptographic sealing section includes a device-embedded key storage core, a hashing transformation circuit, a symmetric-asymmetric hybrid encryption core, and a chaining register that links each event packet to a previous packet hash, thereby forming a continuous integrity chain. Each event packet is time-stamped using a synchronized timing oscillator from the time-stamping section and is sealed into an encrypted log block.

The secure memory vault section comprises physically segmented memory regions enclosed by access control gates that are electrically isolated from the main processing section except through authenticated data pathways. Each log block is written to a vault segment along with its integrity signature and verification metadata. The vault includes tamper detection circuits that trigger encryption re-keying and data lockdown upon unauthorized structural access.

The privacy enforcement section includes identity verification circuits, access rule matrices, data masking engines, and disclosure filters. When a request to access stored logs is received, the privacy enforcement section evaluates the request against predefined authorization parameters, masks sensitive fields, and generates a disclosure-limited output stream.

The verification and disclosure section includes a secure interface panel, display rendering circuits, and validation engines capable of reconstructing user interface sessions from encrypted log blocks only after cryptographic integrity is confirmed through the chaining register.

During normal operation, when a user interacts with a graphical or command-based interface, the physical interception pathways in the acquisition section capture the signal transitions in real time. Each interaction is converted into a structured event packet, which is immediately time-stamped and forwarded to the cryptographic sealing section. The sealing section encrypts the packet, computes a chained hash signature, and produces a sealed log block. The sealed block is routed into the secure memory vault and stored within a protected segment.

When verification is required, an authorized request is received by the privacy enforcement section, which authenticates the requester, determines permissible disclosure scope, decrypts only the necessary fields, and forwards the verified output to the disclosure section for controlled rendering. The integrity of the entire interaction chain is confirmed through sequential hash validation.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for data privacy and user interface logging, the system comprising a housing structure enclosing and supporting a plurality of operatively interconnected processing and signal control units, wherein the housing defines an internal protected cavity having physically separated signal routing pathways, and wherein the system comprises:
a user interface interception unit positioned along a signal path extending between a user input surface and a visual output surface, the user interface interception unit being configured to receive, convert, and forward real-time interface interaction signals representing user actions and visual state transitions;
a central processing unit operatively coupled to the user interface interception unit and configured to receive structured interaction event signals;
a cryptographic sealing unit operatively coupled to the central processing unit, the cryptographic sealing unit comprising a key storage processor, a hashing processor, an encryption processor, and a chaining register configured to transform each interaction event signal into a sealed log record bound to a previous log record through a chained integrity reference;
a timing synchronization unit comprising a secure clock source and timestamp generation circuitry configured to apply a time reference to each sealed log record prior to storage;
a secure memory vault unit comprising a plurality of physically isolated memory partitions having gated access conductors, the secure memory vault unit being configured to store the sealed log records and to restrict read and write operations to authenticated pathways;
a privacy enforcement unit operatively coupled to the secure memory vault unit and configured to authenticate log access requests, apply disclosure limitation rules, and selectively decrypt and mask portions of stored log records; and
a verification and disclosure unit operatively coupled to the privacy enforcement unit and configured to validate chained integrity of the sealed log records and reconstruct authorized user interface interaction sequences for controlled presentation; and wherein the central processing unit is configured to coordinate operation of the user interface interception unit, the cryptographic sealing unit, and the timing synchronization unit by issuing event processing triggers upon receipt of structured interaction event signals, initiating timestamp acquisition from the timing synchronization unit, and forwarding the structured interaction event signals together with the corresponding timestamp references to the cryptographic sealing unit for transformation into sealed log records prior to storage within the secure memory vault unit.

2. The system of claim 1, wherein the user interface interception unit comprises a signal capture array arranged between the user input surface and the visual output surface such that all interface interaction signals are routed through the signal capture array prior to reaching the central processing unit, and wherein the signal capture array includes event normalization circuitry that converts raw signal transitions into structured event representations, and wherein the cryptographic sealing unit is physically isolated within a tamper-resistant enclosure region of the housing and comprises a device-bound key storage processor that generates and retains cryptographic keys which are inaccessible to the central processing unit through direct memory access.

3. The system of claim 1, wherein the chaining register of the cryptographic sealing unit is configured to store a previous integrity reference and to combine the previous integrity reference with a current interaction event signal prior to hashing, thereby forming a sequential dependency across all sealed log records, and wherein the timing synchronization unit comprises a dedicated oscillator and a time verification circuit configured to detect clock drift and to prevent the generation of duplicate or regressive timestamps.

4. The system of claim 1, wherein the secure memory vault unit comprises electrically isolated memory segments separated by access gate transistors that remain nonconductive unless an authentication token generated by the cryptographic sealing unit is verified by the privacy enforcement unit, and wherein the secure memory vault unit further comprises a tamper detection conductor grid embedded within the housing, the grid being configured to trigger memory lockdown and cryptographic key invalidation when physical breach of the housing is detected.

5. The system of claim 1, wherein the privacy enforcement unit comprises an identity verification processor, an access policy comparator, and a data masking processor configured to remove or obfuscate selected fields from the sealed log records prior to disclosure, and wherein the data masking processor is configured to replace visual content segments of the sealed log records with structural metadata representations that preserve event sequence while removing user-identifiable content.

6. The system of claim 1, wherein the verification and disclosure unit comprises an integrity validation processor configured to sequentially recompute chained integrity references and to generate a validation status prior to permitting reconstruction of any user interface interaction sequence.

7. The system of claim 2, wherein the event normalization circuitry of the signal capture array is configured to intercept heterogeneous signal transitions originating from the user input surface and the visual output surface and to convert the intercepted signal transitions into structured interaction event representations by sequentially sampling signal voltage variations, detecting transition edges, mapping the detected transition edges to predefined interaction event categories, and generating standardized event packets containing event type identifiers, positional references, and state-change indicators, and wherein the structured event packets are transmitted to the central processing unit through a dedicated routed pathway that bypasses unverified intermediate logic paths; and wherein the signal capture array further comprises a buffering controller configured to temporarily queue the structured interaction event representations in a controlled sequence and to regulate forwarding of the structured interaction event representations to the central processing unit in synchronization with receipt acknowledgment signals, such that no interaction event representation is lost, overwritten, or reordered during transmission.

8. The system of claim 3, wherein the chaining register is configured to combine the stored previous integrity reference with the current interaction event signal by concatenating a representation of the previous integrity reference with a structured representation of the current interaction event signal and a corresponding timestamp reference received from the timing synchronization unit prior to forwarding the combined data to the hashing processor, such that each sealed log record is formed as a dependent transformation of both a preceding sealed log record and a current interaction event; and wherein the timing synchronization unit is configured to coordinate generation of timestamp references by continuously comparing oscillation cycles from the dedicated oscillator against a reference cycle counter, identifying timing irregularities, and inhibiting timestamp generation when a deviation beyond a predefined drift tolerance is detected, and wherein the timing synchronization unit resumes timestamp issuance only after a verified time alignment condition is re-established.

9. The system of claim 4, wherein the authentication token generated by the cryptographic sealing unit is dynamically produced for each write operation by deriving a token value from at least a portion of the sealed log record and a time reference generated by the timing synchronization unit, and wherein the privacy enforcement unit is configured to validate the token value prior to enabling conduction through the access gate transistors of a selected memory partition to permit storage of the sealed log record; and wherein the tamper detection conductor grid is configured to continuously circulate a verification signal through intersecting conductive traces embedded within the housing, and wherein interruption, attenuation, or distortion of the verification signal results in generation of a tamper event signal that is routed to the cryptographic sealing unit to initiate immediate invalidation of active cryptographic key references stored within the key storage processor.

10. The system of claim 5, wherein the identity verification processor of the privacy enforcement unit is configured to receive an access request containing a requester identity representation and to generate a verification result by comparing the requester identity representation with stored authentication credentials, and wherein the access policy comparator is configured to evaluate the verification result against a set of disclosure limitation rules to determine permitted fields within the sealed log records for disclosure; and wherein the data masking processor is configured to process the sealed log records by identifying visual content segments associated with user interface rendering states, extracting structural parameters including event timing, interaction type, and interface region reference, and replacing pixel-level or character-level content with encoded structural metadata tokens that retain interaction sequence continuity while suppressing user-identifiable data elements.

11. The system of claim 6, wherein the integrity validation processor is configured to sequentially retrieve stored sealed log records from the secure memory vault unit, extract a stored chained integrity reference from each sealed log record, recompute a corresponding integrity value by combining a preceding integrity reference with associated structured interaction event representations and timestamp references, and compare the recomputed integrity value with the stored chained integrity reference to determine continuity of the sealed log record chain.

12. The system of claim 6, wherein the verification and disclosure unit further comprises a sequence reconstruction processor configured to reconstruct authorized user interface interaction sequences by arranging validated sealed log records in chronological order based on the applied time references, decoding structured interaction event representations, and generating a controlled playback representation corresponding to permitted disclosure parameters defined by the privacy enforcement unit.

13. The system of claim 2, wherein the device-bound key storage processor is configured to generate cryptographic keys through an internal entropy derivation process using time-varying electrical characteristics measured within the tamper-resistant enclosure region, and wherein the generated cryptographic keys are supplied directly to the hashing processor and the encryption processor through internal conductors that are not externally addressable by the central processing unit.

14. The system of claim 3, wherein the encryption processor is configured to transform each hashed interaction event representation into a sealed log record by applying an encryption transformation that incorporates the hashed value, the timestamp reference, and a device-bound key obtained from the key storage processor, and wherein the encrypted output is written into the chaining register as a current integrity reference for use in generation of a subsequent sealed log record.

15. The system of claim 4, wherein the secure memory vault unit is configured to distribute successive sealed log records across different physically isolated memory partitions according to a partition allocation controller that assigns a storage location based on at least a portion of the chained integrity reference, such that sequential sealed log records are not stored within a single contiguous memory segment.
